(19) United States
(12) Patent Application Publication
(10) Pub. No.: US 2009/0027632 A1
(43) Pub. Date: Jan. 29, 2009

(54) Bag type presentation apparatus

(76) Inventor: Hae-Yong Choi, Seoul-City (KR)

Correspondence Address: BACON & THOMAS, PLLC, 625 SLATERS LANE, FOURTH FLOOR, ALEXANDRIA, VA, 22314-1176, US

(21) Appl. No.: 11/987,045

(22) Filed: Nov. 27, 2007

Related U.S. Application Data
(63) Continuation-in-part of application No. 11/878,194, filed on Jul. 23, 2007.

(30) Foreign Application Priority Data
Aug. 27, 2007 (KR) 10-2007-0085973

(51) Int. Cl. G03B 21/28

(52) U.S. Cl. 353/98

(57) ABSTRACT

A bag type presentation apparatus is disclosed. The apparatus includes a bag-shaped case body having an upper case and a lower case, a curved reflective screen having a focus, and a small projector. The reflective screen is mounted at an inner surface of the upper case and has a reflectance of 4 to 50%. The reflective screen is a curved or spherical reflective screen or a fresnel reflective screen, to straightly reflect a light projected from the small projector located at the focal position thereof, thereby preventing a hot spot and realizing a high screen brightness of 4 to 50 times that of a conventional screen. The projector uses a LED as a light source and has a weight and volume of a fourth that of a conventional projector. The projector is positioned at a focal position of the reflective screen based on the curvature of the reflective screen when in use, and is received in the bag-shaped body case when being carried.

### BACKGROUND OF THE INVENTION

1. Field of the Invention

The present invention relates to a video conference apparatus, and more particularly, to a bag type presentation apparatus, wherein a screen having a curved or spherical reflective plane is mounted in a bag-shaped case to reflect a light projected from a small projector using a diode as a light source, the small projector being located at a focal position of the screen, whereby the screen can achieve a good brightness and vividness.

This application is a continuation-in-part of U.S. patent application Ser. No. 11/878,194, which was previously filed on Aug. 6, 2007 by the applicant of the present invention and titled “BAG TYPE PORTABLE SCREEN DEVICE”. That is, this application deals with one kind of a bag type portable screen device in which a reflective screen is coupled with a bag-shaped coupling system to achieve an increased brightness of 4 to 50 times that of the prior art.

2. Description of the Related Art

Conventionally, many technologies related to screens suitable to be installed in a bag-shaped structure have been developed. However, most conventional screens for use with the bag-shaped structure are flat or transmission screens, and have a low brightness unsuitable for use in the light places. Further, most conventional projectors have a problem in that they are very inconvenient to carry because of a larger size than that of a bag and a heavy weight thereof.

Currently, there is increasing a need for video conference apparatuses for use in various business activities such as an insurance business, car-sale business, etc. or in lecturing or military drill activities, to present an image and other data as occasion demands.

In the case of conventional video conference apparatuses, they use a laptop computer having a size of 15 to 17 inches. However, the laptop computer has a small-size, low-brightness screen and thus, is unpractical.

Furthermore, with the use of a large volume and heavy weight projector, the conventional video conference apparatuses have a need for a supporting stand. In this case, since a weight of the projector is 0.3 kg or more, a weight of a protecting bag is 1 kg or more, a weight of a screen is 5 to 10 kg or more, a weight of the screen stand is 5 kg or more and a weight of laptop computer is about 2 kg, the total weight of the resulting video conference apparatus may exceed 20 kg. In addition, the large number of incidental articles makes it difficult for a user to carry the video conference apparatus.

As known, a plasma display panel (PDP) and a liquid crystal display (LCD) are impossible to use as a portable device since their weight is, for example, about 14 kg based on a size of 26 inches and about 30 kg based on a size of 30 to 40 inches. The PDP and the LCD also have an average brightness of only about 300 cds/m², and have a difficulty to provide a vivid image in the light places and cannot achieve a satisfactory image displaying effect.

### SUMMARY OF THE INVENTION

Therefore, the present invention has been made in view of the above and/or other problems, and it is an object of the present invention to provide a bag type presentation apparatus, which is convenient to carry with the use of a bag-shaped body case and can achieve not only a high screen brightness of 2 or more times that of a conventional LCD screen, but also a large screen size of 21 to 40 inches beyond 2 times that of the conventional LCD screen despite a considerably reduced weight of about a half that of the conventional LCD screen, thereby being usable in the light places such as indoor shops, offices, well-lighted rooms, etc.

It is another object of the present invention to provide a bag type presentation apparatus in which a projector, a screen, a screen stand, a laptop computer, etc. are mounted in a single bag structure, thereby achieving a light weight and a convenience in carrying.

Here, it is noted that the projector suitable for the above described configuration should have a size of about a half that of a normal bag, and preferably, have a size of about a quarter that of the normal bag.

Representative examples of the projector include small projectors such as a mini-projector having a size suitable to be put into a bag, or a pocket projector having a size suitable to be put into a pocket.

However, in the case of the mini-projector, due to a limit in the installation of a cooling system capable of cooling a light source, it cannot use a lamp emitting a great amount of heat. Therefore, the brightness of the mini-projector has a very low value of about ¼ to 1/10 that of a large-size projector. Also, although the pocket-projector mainly uses an LED or laser diode and does not emit heat, the brightness of the pocket-projector also has a very low value of about 1/10 to 1/50 that of a large-size projector.

Accordingly, it is yet another object of the present invention to provide a bag type presentation apparatus, in which a screen to be installed in a bag structure can achieve a brightness of 4 to 50 times that of the prior art despite the use of a small projector such as a mini-projector or pocket-projector, to present a vivid and bright image in the light places.

In accordance with the present invention, the above and other objects can be accomplished by the provision of a bag type presentation apparatus comprising: a reflective screen having a regular curvature; a small projector located at a focal position of the reflective screen to realize a screen brightness of 4 to 50 times that of a conventional screen; and a bag-shaped case for receiving the reflective screen and the small projector therein to assure a convenience in carrying.

### BRIEF DESCRIPTION OF THE DRAWINGS

These and/or other aspects and advantages of the present invention will be come apparent and more readily appreciated from the following description of the embodiments, taken in conjunction with the accompanying drawings, in which:

FIG. 1 is a perspective view illustrating the outer appearance of a bag type presentation apparatus according to the present invention;

FIG. 2 is a view of the bag type presentation apparatus in a state of carrying;

FIG. 3 is an explanatory view illustrating the configuration of a small projector;

FIG. 4 is an explanatory view illustrating a hot spot caused in a conventional flat-plane screen;

FIG. 5 is an explanatory view illustrating the elimination of the hot spot using a spherical reflective screen and a projector located at the focal position of the reflective screen;

FIGS. 6A to 6C are explanatory views illustrating the operation of a curved reflective screen having a regular curvature;

FIGS. 7A and 7B are explanatory views illustrating the operation of a spherical reflective screen having a regular curvature;

FIG. 8 is an explanatory view of the present invention in a state of use;

FIG. 9 is an explanatory view illustrating a bag type presentation apparatus according to an embodiment of the present invention;

FIG. 10A is an explanatory view illustrating a bag type presentation apparatus according to another embodiment of the present invention;

FIG. 10B is an explanatory view illustrating the use of the apparatus shown in FIG. 10A;

FIG. 11A is an explanatory view illustrating a bag type presentation apparatus according to yet another embodiment of the present invention; and

FIG. 11B is an explanatory view illustrating the use of the apparatus shown in FIG. 11A.

### DESCRIPTION OF THE PREFERRED EMBODIMENTS

First, the configuration of a bag type presentation apparatus according to the present invention will be described with reference to the accompanying drawings.

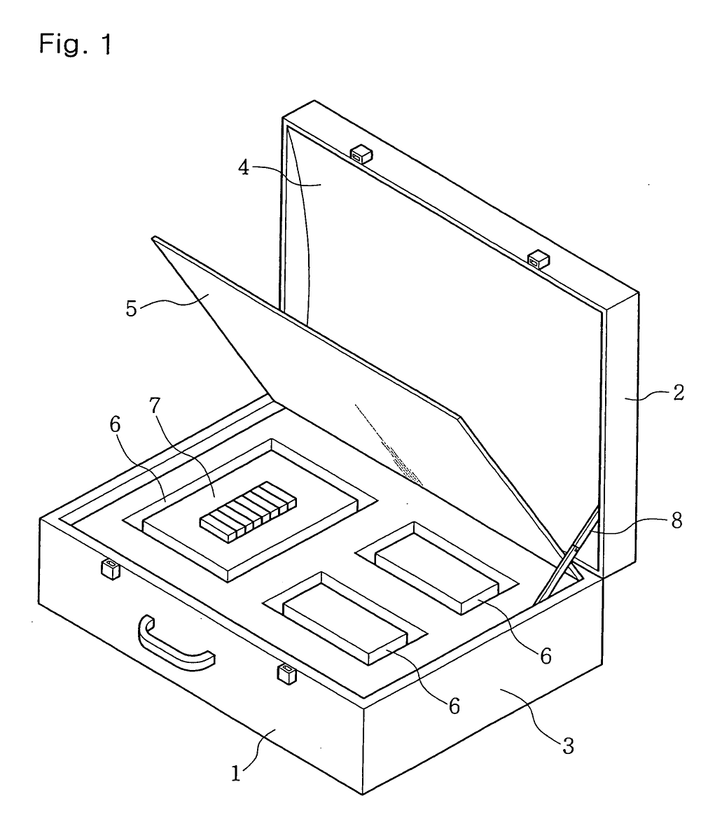

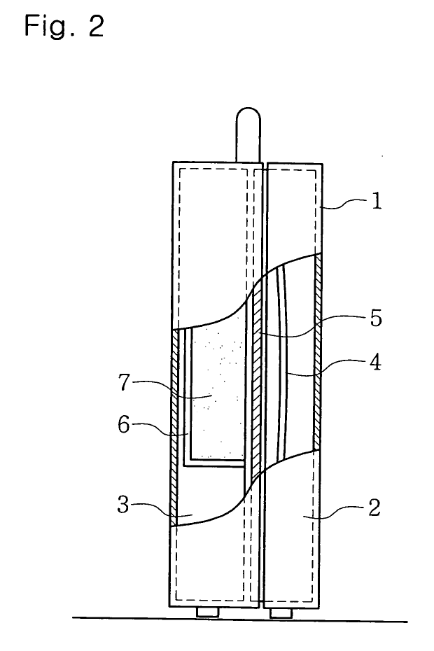

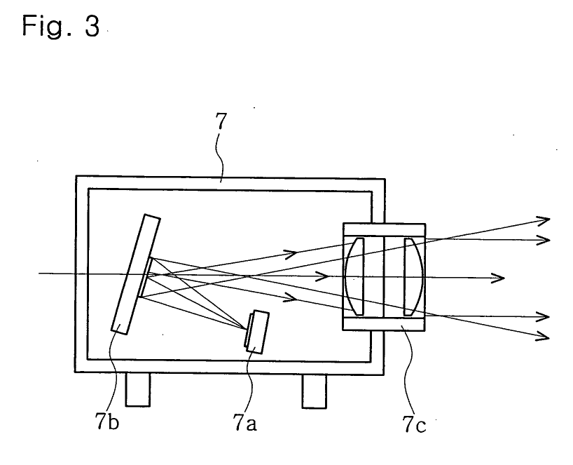

As shown in FIGS. 1 and 3, the bag type presentation apparatus of the present invention comprises: a bag-shaped body case 1 consisting of an upper case 2 and a lower case 3; a reflective screen 4 mounted at an inner surface of the upper case 2; and a small projector 7 received in one of a plurality of storage boxes 6 provided in the lower case 3. The storage boxes 6 are made of a shock-absorbing material such as sponge, etc.

In addition to the small projector 7, the storage boxes 6 are used to receive a small computer such as a laptop computer, an image-display device such as a DVD player, a small amplifier, a speaker, etc.

An angle adjustor 8 is provided between the upper case 2 and the lower case 3, to adjust a vertical reflection angle of the reflective screen 4 mounted at the upper case 2. A protecting panel 5 is also provided between the upper case 2 and the lower case 3, to protect a surface of the reflective screen 4 from the small projector 7 mounted in the lower case 3.

The small projector 7, as shown in FIG. 3, includes a light source 7a such as a light emitting diode (LED) or laser diode.

As shown in FIG. 3, the small projector 7 further includes a digital light processing (DLP) chip 7b, a projection lens 7c, and a drive circuit (not shown). Since the light source 7a used in the small projector 7 has a size of less than a tenth of the size of a metal halide lamp, mercurial lamp, or the like used in conventional projectors, the small projector 7 according to the present invention has a size suitable to be put into a pocket. Furthermore, the light source 7a emits no heat, and thus, has no need for a cooling fan, etc. As a result, the overall height of the small projector 7 can be reduced to a fifth the weight of conventional projectors.

In conclusion, the small projector 7 according to the present invention is suitable to be mounted in the briefcase-shaped lower case 3, thus enabling the formation of the bag type presentation apparatus.

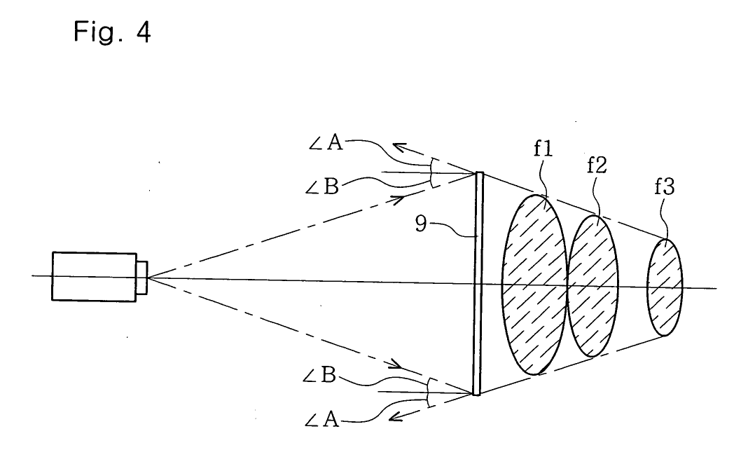

However, the small projector 7 has a limit to project a sufficiently bright light. More particularly, the light projected from the small projector 7 has a brightness of only a tenth to a fifth that of conventional projectors. Therefore, to realize a sufficiently bright image even when using the small projector 7, it is necessary to provide a special screen having a high brightness. As an example of the special screen, FIG. 4 illustrates a screen 9 having a high reflectance.

In the case of the screen 9 shown in FIG. 4, however, if the small projector 7 projects a light onto a reflective plane of the flat-plane type screen 9, hot spots f1, f2, and f3 appear in a region belonging to an inverted angle of an incident angle ∠B and a reflection angle ∠A. The hot-spots are zones causing the surrounding image to be invisible and are caused because only a partial region of the overall screen is bright.

The greater the reflectance of a screen, the smaller the size of the hot spot, but the greater the brightness of the hot spot (See the hot spot f3). On the contrary, the smaller the reflectance of a screen, the greater the size of the hot spot, but the greater the brightness of the hot spot (See the hot spots f1 and f2).

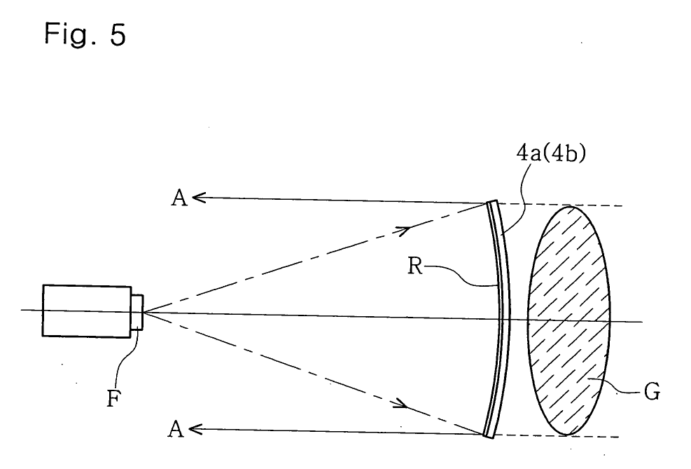

To eliminate such a hot spot, as shown in FIG. 5, the present invention proposes that the reflective screen 4 has a curved or spherical plane and the small projector 7 is located at a focal position F of the reflective screen 4. Here, a curvature R of the curved or spherical plane of the reflective screen 4 and the focal position F of the reflective screen 4 are determined to fulfill an expression F=R/2.

With the above described configuration, even if the reflective screen 4 has a significantly high surface reflectance, the reflective screen 4 reflects a light projected from the small projector 7 located at the focal position F thereof in a straight direction A. Accordingly, a region G belonging to an inverted angle of the reflection angle ∠A has an even brightness, enabling the formation of a bright screen having no hot spot.

In the present invention, it should be noted that the curved or spherical plane of the reflective screen 4 must have a regular curvature R similar to a lens.

The reason why the reflective screen 4 must have a regular curvature R is that the screen has a higher surface reflectance than that of conventional screens and therefore, is liable to show an uneven brightness under the condition of an irregular curvature, thus being functionally disordered.

Hereinafter, preferred embodiments of the reflective screen 4 will be described in detail.

### First Embodiment

In the present embodiment, there is provided a curved reflective screen 4a.

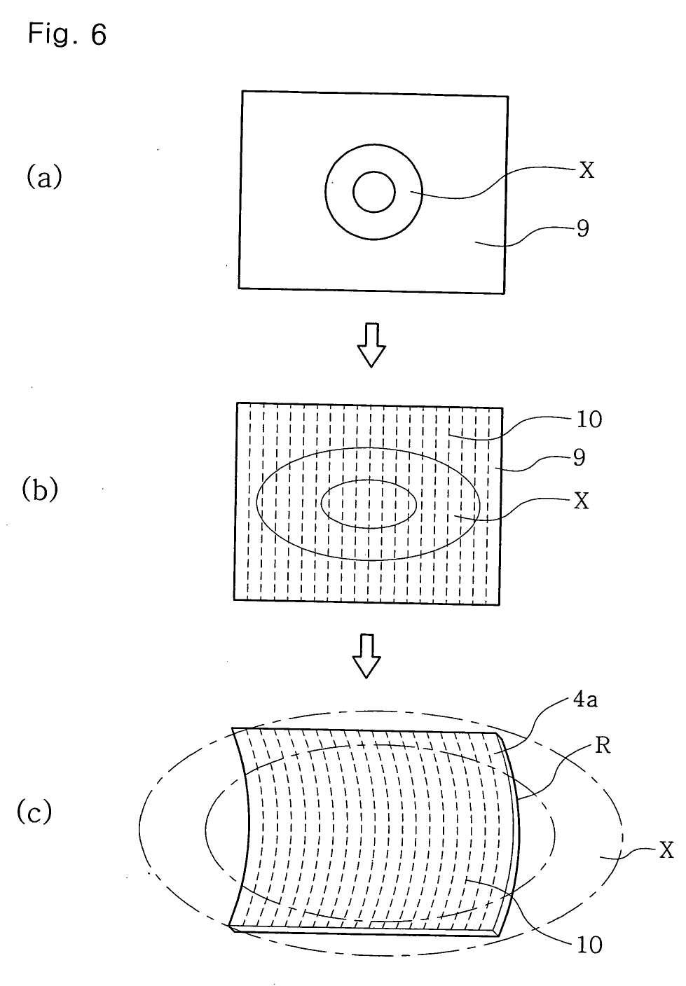

In the case of a conventional flat-plane screen 9, as shown in FIG. 6A, it causes a hot spot x due to a reflective plane defined at a screen surface.

Referring to FIG. 6B, when horizontal scattering lines 10 are formed on the surface of the screen 9 to scatter a light in a horizontal direction, the hot spot x is expanded only in the horizontal direction.

In the present embodiment, it is proposed to provide the screen having the horizontal scattering lines 10 with a vertically curved plane having a regular curvature R as shown in FIG. 6C. Also, it is proposed to position the small projector 7 at the focal position F of the curved reflective screen having the regular curvature R. With this configuration, the hot spot x, which was expanded horizontally by the scattering lines 10, is again expanded vertically, to realize a screen having an even brightness.

In this case, as a result that a light introduced onto the curved reflective screen 4a is scattered in a horizontal direction and expanded in a vertical direction, the curved reflective screen 4a has a brightness of 4 to 10 Gains, i.e. 4 to 10 times that of conventional screens.

Here, the brightness of the curved reflective screen 4a is below 8 Gain since the scattering lines 10 are formed only in one of horizontal and vertical directions to diffuse a light.

It will be appreciated that the same result can be obtained even when the scattering lines 10 are formed vertically and the screen is curved horizontally, contrary to the above described embodiment.

In brief, the present embodiment has a feature that the scattering lines 10 are formed in one of vertical and horizontal directions of the screen and the screen is curved in the other direction by a regular curvature.

The scattering lines 10 may be obtained by various ways, for example, by providing the screen surface with various embossing patterns or by coating the screen surface with a diffusive material.

As the curved reflective screen 4a having a regular curvature according to the present embodiment is mounted to the upper case 2 of the bag-shaped body case 1, the bag type presentation apparatus can be accomplished.

### Second Embodiment

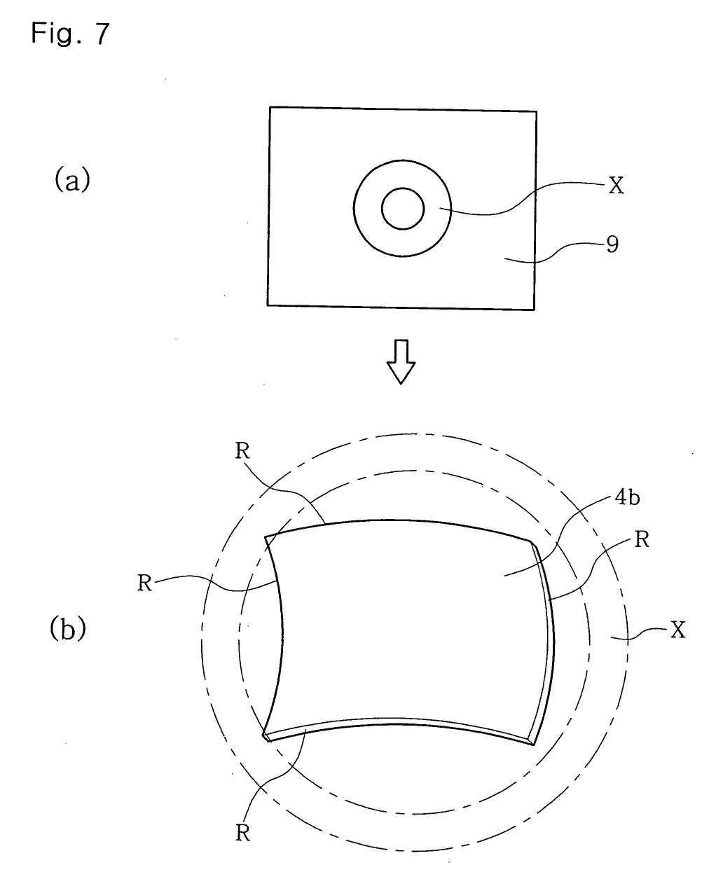

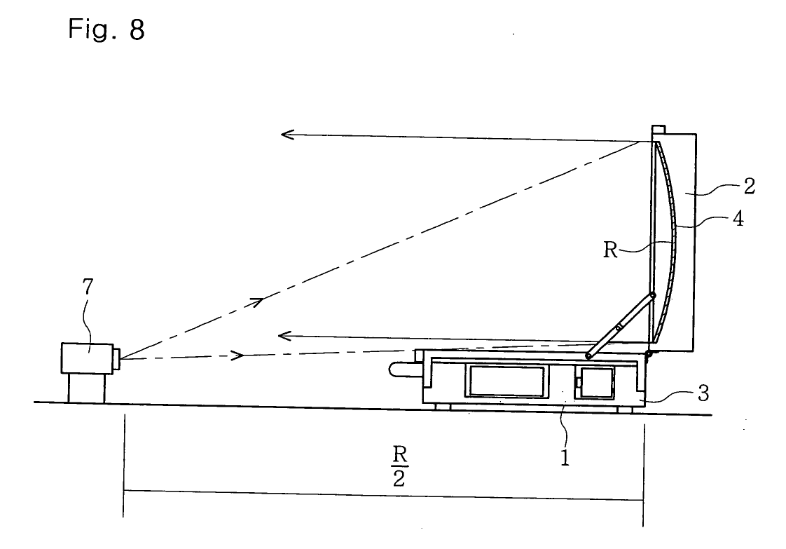

Referring to FIGS. 7A and 7B, there is provided a spherical reflective screen 4b having a regular curvature. In the present embodiment, the spherical reflective screen 4b has a surface reflectance of 4% to 50%, and a curvature R of the spherical reflective screen 4b is determined to be 2 times a projection distance of the small projector 7. With this configuration, by positioning the small projector 7 at a half position R/2 of the curvature R of the reflective screen 4 as shown in FIG. 8, a light projected from the small projector 7 onto the spherical reflective screen 4b is reflected straight as shown in FIG. 8, to realize a bright screen having no hot spot x.

The screen of the present embodiment can achieve a brightness of 4 to 50 Gains, i.e. 4 to 50 times 1 Gain of conventional screens. Here, 1 Gain means a reflectance of 1%.

As the spherical reflective screen 4b having a regular curvature according to the present embodiment is mounted to the upper case 2 of the bag-shaped body case 1, the bag type presentation apparatus can be accomplished.

### Third Embodiment

In the present embodiment, there is provided a fresnel reflective screen 4C.

As known, a fresnel film 11 is a substantially flat thin film, and functions to refract a light projected from a focal position thereof similar to a refractive lens.

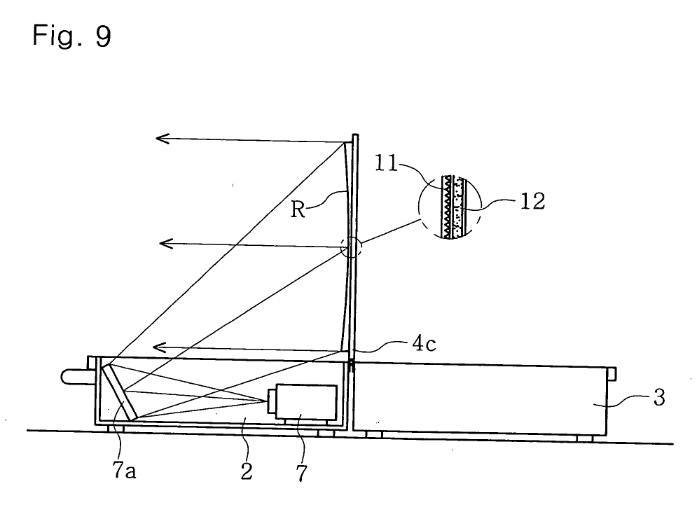

As shown in FIG. 9, a protecting panel 5 is provided at a middle region of the bag-shaped body case 1 between the upper case 2 and the lower case 3, and the fresnel reflective screen 4C is mounted at a front surface of the protecting panel. A reflective mirror 14 and the small projector 7 may be mounted in a rear end region of the lower case 3, or only the small projector 7 may be disposed at a focal position F of the fresnel reflective screen 4C without the reflective mirror 14. In the present embodiment, the fresnel reflective screen 4C may be mounted at the inner surface of the upper case 3, and the upper case 3 is vertically erected in use.

The fresnel reflective screen 4C, as shown in FIG. 9, has a reflective plane 12 at a rear surface of the fresnel film 11, and the reflective plane 12 has a reflectance of 4% to 50%.

The reflective plane 12 of the fresnel reflective screen 4C is very efficient for reflecting straight an image projected from the focal position F, thereby achieving the high reflectance of 4% to 50%.

With the above described configuration, when an image from the small projector 7 is projected from the focal position F, the image can be reflected straight by the fresnel reflective screen 4C to have a brightness of 4 to 50 times that of conventional screens, by virtue of the refraction of the fresnel film 11 and the reflection of the reflective plane 12.

In brief, the reflective plane 12 and the fresnel film 11 exhibit reflection and refraction functions together, and the fresnel film 11 has a spherical plane having a regular curvature R.

As the fresnel reflective screen 4C having the reflection and refraction functions according to the present embodiment is mounted to the upper case 2 of the bag-shaped body case 1, the bag type presentation apparatus can be accomplished.

### Fourth Embodiment

The same effect as that of the above described third embodiment can be obtained even when the fresnel reflective screen 4C is provided at a rear surface of the protecting panel 5.

In the present invention, it is important to position the small projector 7 at the focal position F of the reflective screen 4. Therefore, there is a need for a method for automatically coinciding a projection distance of the projector with the focal position F of the screen.

The projection distance of the projector is determined by the condition of a projection lens. For example, in the case of a projector system in which a screen has a size of 40 inches and a projection distance is 1 m, if the screen has a curvature R of 2,000 R, the focal position F of the screen is spaced apart from the screen by a distance of 1 m. Accordingly, when a light is projected on the 40-inch screen at the projection distance of 1 m, the projection distance automatically coincides with the focal position.

In conclusion, by determining the projection distance of the projector based on the size of the screen under the assumption that the projection distance is automatically set to a half the curvature R of the screen, the position of the projector is automatically set to the position of the focal position F of the screen having a curvature R.

The above described principle is similarly applicable to the focal position and the projection distance of the fresnel film 11.

### Fifth Embodiment

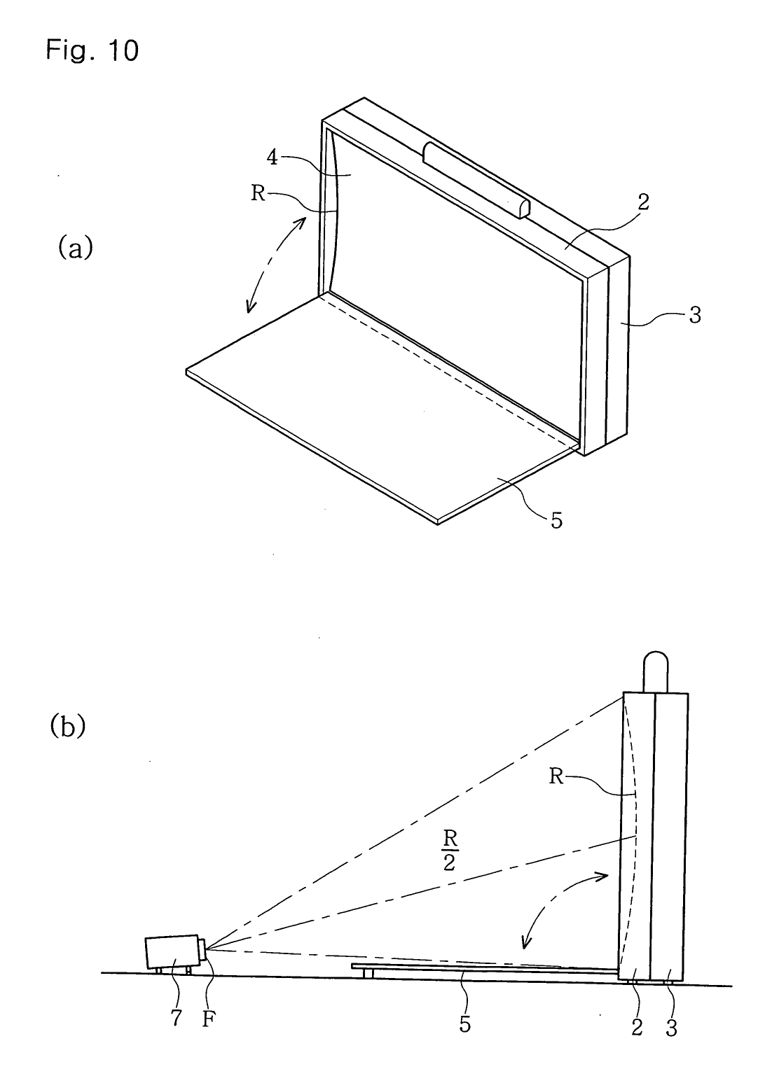

As shown in FIGS. 10A and 10B, the reflective screen 4 is provided at an outside surface of the upper case 2 of the bag-shaped body case 1, and the protecting panel 5 as a projective cover is connected to the reflective screen 4 to open or close the reflective screen 4 via a pivotal rotation thereof.

The reflective screen 4 may be selected from among the above described curved reflective screen 4a, spherical reflective screen 4b, fresnel reflective screen 4c, and other screens, such that, as shown in FIG. 10B, the reflective screen 4 has a spherical plane having a regular curvature R and a reflectance of 4% to 50%.

In use of the present embodiment, as shown in FIGS. 10A and 10B, the bag-shaped body case 1 is vertically erected and the protecting panel 5 is opened. Also, the small projector 7 is positioned at a half distance R/2 of the curvature R of the reflective screen 4, i.e. at the focal position of the reflective screen 4. Upon carrying, the reflective screen 4 is closed by the protecting panel 5.

The operational effects of the reflective screen 4 are identical to those of the above described reflective screens 4a, 4b, and 4c.

### Sixth Embodiment

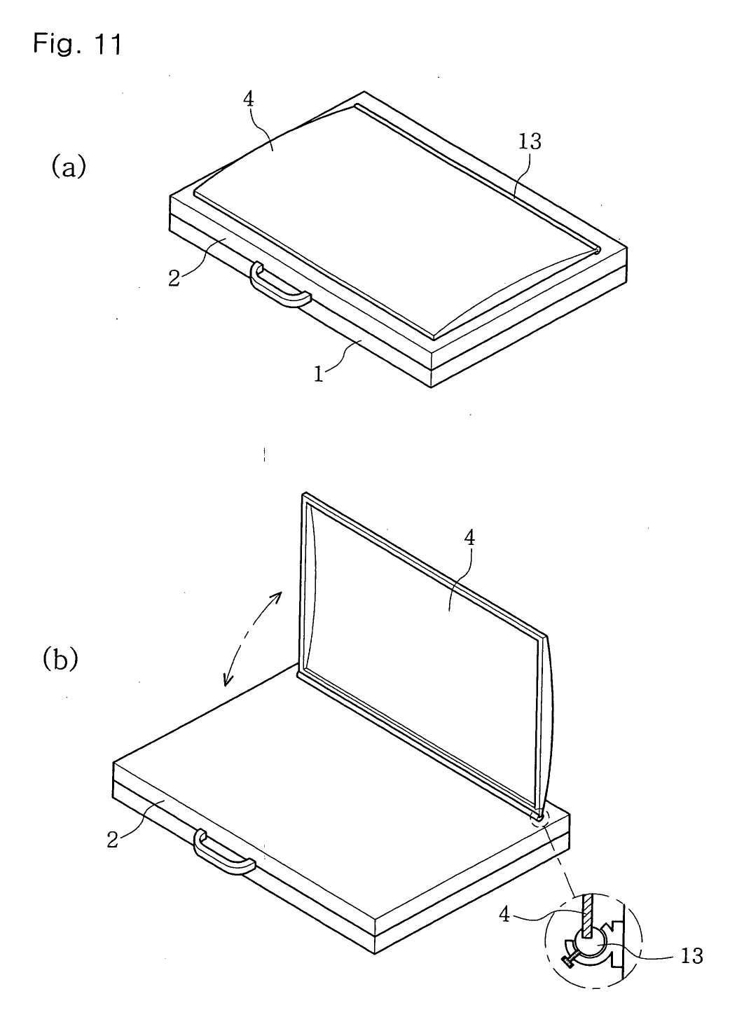

As shown in FIG. 11A, the reflective screen 4, which may be selected from among the above described curved reflective screen 4a, spherical reflective screen 4b, fresnel reflective screen 4c, and other screens, is provided at the outer surface of the upper case 2 of the bag-shaped body case 1 by use of a pivotally rotatable bracket 13.

The reflective screen 4 has a spherical plane having a regular curvature R and a reflectance of 4% to 50%.

In use of the present embodiment, as shown in FIG. 11B, the reflective screen 4 is pivotally rotated to be opened. Upon carrying, as shown in FIG. 11A, the reflective screen 4 is closed. Thereby, the reflective screen 4 can constitute a part of the portable bag type presentation apparatus.

As apparent from the above description, the present invention provides the following several effects.

Firstly, as shown in FIG. 6, with the provision of the curved reflective screen 4a capable of eliminating a hot spot by light diffusion effects of horizontal scattering lines thereof and a vertical curved reflective plane thereof having a regular curvature, the present invention can achieve a screen brightness of 4 to 10 Gains. As a result, even when using the small projector 7 having a low brightness of 200 ANSI, a bright screen having a high brightness of 800 to 1800 ANSI can be realized.

Secondly, when providing the spherical reflective screen 4b having a regular curvature as shown in FIG. 7, a surface reflectance of the spherical reflective screen can be increased up to 1 to 50 times the reflectance (i.e 1 Gain) of conventional screens. As a result, even when using the small projector having a low brightness of 200 ANSI (63 cds/m²), a high screen brightness of 2,000 to 10,000 ANSI can be realized without the risk of a hot-spot.

Specifically, since the above mentioned brightness is equal to a value of 630 cds/m² to 3,184 cds/m², the screen can achieve a brightness of 2 to 10 times the brightness (i.e. 300 cds/m²) of conventional laptop computers. Accordingly, the bag type presentation apparatus using the bright screen can be used in various places, for example, in the open air for military drills, offices, and exhibition halls, to provide a vivid image even in the light.

Thirdly, when using the fresnel reflective screen 4c as shown in FIG. 9, a reflectance of 4 to 50 times that of conventional screens, i.e. a brightness of 4 to 50 Gains can be accomplished.

Specifically, according to the present invention, by adjusting the surface reflectance and the curvature R of the reflective screen 4, it is possible to allow a low-brightness light, projected from the small projector 7 at the focal position F of the reflective screen 4, to be remarkably enhanced by being refracted at the focal position F.

Fourthly, the present invention can realize a large-size screen of 24 inches to 40 inches. This is a size of 2 to 5.5 times that of a conventional 17-inch screen.

As a result of measuring the weight of the resulting bag-type presentation apparatus according to the present invention, the total weight of the 26-inch screen and the small projector 7 is only 4.5 kg. This is a weight of only a third that of a conventional 26-inch LCD having a weight of 14 kg.

Fifthly, since the small projector 7 uses a LED or laser diode as the light source 7a, the small projector 7 can achieve a reduced volume of a tenth the volume of a conventional projector. Accordingly, the small projector is suitable for being mounted in a bag structure, and enables the formation of the bag type presentation apparatus to be easy to carry and store.

In conclusion, the bag type presentation apparatus, which is easy to carry, can be widely used for various purposes. For example, the bag type presentation apparatus is usable as a portable presentation apparatus for business members, a portable education apparatus for use in schools and companies, a portable image-display apparatus for use in exhibition halls and show rooms, and military field equipment as well as military briefing apparatuses.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A bag type presentation apparatus comprising:
a bag-shaped body case including an upper case and a lower case;
a reflective screen mounted at an inner surface of the upper case and having a curved or spherical reflective plane of a regular curvature, the reflective plane having a reflectance of 4% to 50% and performing a light reflection/refraction function; and
a small projector, which is positioned at a focal position of the reflective screen based on the curvature of the reflective screen when in use, and is received in the bag-shaped body case when being carried.

2. The bag type presentation apparatus according to claim 1, wherein the small projector includes a light source having a minimized volume suitable to be received in the bag-shaped body case.

3. The bag type presentation apparatus according to claim 1,
wherein the reflective screen is a curved reflective screen having a regular curvature and a surface reflectance of 4% to 10%, scattering lines being formed in one of horizontal and vertical directions of the screen, and the screen being curved in the other direction, and
wherein the curved reflective screen straightly reflects an image projected from a focal position thereof determined based on the curvature and the surface reflectance of the curved reflective screen.

4. The bag type presentation apparatus according to claim 1,
wherein the reflective screen is a spherical reflective screen having a regular curvature and a surface reflectance of 4% to 50%, and
wherein the spherical reflective screen straightly reflects an image projected from a focal position thereof determined based on the surface reflectance and the curvature of the spherical reflective screen.

5. The bag type presentation apparatus according to claim 1,
wherein the reflective screen is a fresnel reflective screen having a regular curvature, the fresnel reflective screen including a reflective plane having a surface reflectance of 4% to 50% and a fresnel film.

6. The bag type presentation apparatus according to claim 1,
wherein the reflective screen having the regular curvature is provided at an outer surface of the upper case of the bag-shaped body case, and wherein the bag type presentation apparatus further comprises a protecting panel to cover the reflective screen.

7. The bag type presentation apparatus according to claim 1, wherein the reflective screen is provided at an outer surface of the upper case of the bag-shaped body case, and is arranged to be pivotally rotatable in a vertical direction.
